(19) United States
(12) Patent Application Publication
(10) Pub. No.: US 2024/0105385 A1
(43) Pub. Date: Mar. 28, 2024

(54) METHOD OF MANUFACTURING R-T-B BASED SINTERED MAGNET, AND R-T-B BASED SINTERED MAGNET

(71) Applicant: TDK CORPORATION, Tokyo (JP)

(72) Inventor: Suguru SATOH, Tokyo (JP)

(73) Assignee: TDK CORPORATION, Tokyo (JP)

(21) Appl. No.: 18/466,177

(22) Filed: Sep. 13, 2023

(30) Foreign Application Priority Data
Sep. 22, 2022 (JP) 2022-151435
Jul. 14, 2023 (JP) 2023-116168

(51) Int. Cl. H01F 41/02; H01F 1/057

(52) U.S. Cl. CPC H01F 41/0293; H01F 1/0577; H01F 41/0266

(57) ABSTRACT

A method of manufacturing an R-T-B based sintered magnet comprises heating a composition to give an alloy powder, cleaning the alloy powder using a cleaning solution, molding the cleaned alloy powder to give a green compact, and sintering the green compact to give a sintered body. The composition comprises a rare-earth metal element, a transition metal element, boron, and a metal halide. The metal halide comprises at least one selected from the group consisting of an alkali metal halide, an alkaline earth metal halide, and a halide of the rare-earth metal element. The heating is performed at a heating temperature that is not lower than a melting point of the metal halide. The cleaning solution comprises an aprotic solvent and is capable of dissolving the metal halide.

### TECHNICAL FIELD

The present invention relates to a method of manufacturing an R-T-B based sintered magnet and an R-T-B based sintered magnet.

### BACKGROUND

As a method of producing an alloy powder used for manufacture of an R-T-B based sintered magnet, known is a method of casting an alloy using a casting method (e.g., strip casting) and then pulverizing the alloy using a pulverizing method (e.g., jet milling). Unfortunately, in this method, there is a limit to the extent to which the particle size of the resulting alloy powder is reduced. Specifically, it is difficult to reduce the particle size of the alloy powder to about 1 μm or less. The smaller the particle size of the alloy powder used for manufacture of the R-T-B based sintered magnet, the more readily are the magnetic characteristics, particularly coercivity, of the R-T-B based sintered magnet improved. Thus, a manufacturing method in place of the pulverizing method has been in demand.

Patent Document 1 discloses a method of producing an alloy powder with an average particle size of 1 to 10 μm using a Ca reduction diffusion method, not the pulverizing method. However, when the Ca reduction diffusion method is used, water or a weak acid, which are protic solvents, is essential for cleaning an alloy powder. At cleaning, oxidized layers are formed on surfaces of particles. When the alloy powder has many oxidized layers, sintering does not readily proceed. Thus, it is difficult to obtain a high-density sintered body through sintering the alloy powder produced by the Ca reduction diffusion method.
Patent Document 1: Japanese Laid-Open Patent Publication No. S59-219404

### SUMMARY

It is an object of an exemplary embodiment of the present invention to provide a method of manufacturing an R-T-B based sintered magnet having a high sintered density.

To achieve the above object, a method according to an exemplary embodiment of the present invention of manufacturing an R-T-B based sintered magnet is a method of manufacturing an R-T-B based sintered magnet, comprising:
heating a composition to give an alloy powder;
cleaning the alloy powder using a cleaning solution;
molding the cleaned alloy powder to give a green compact; and
sintering the green compact to give a sintered body,
wherein
the composition comprises a rare-earth metal element, a transition metal element, boron, and a metal halide;
the metal halide comprises at least one selected from the group consisting of an alkali metal halide, an alkaline earth metal halide, and a halide of the rare-earth metal element;
the heating is performed at a heating temperature that is not lower than a melting point of the metal halide; and
the cleaning solution comprises an aprotic solvent and is capable of dissolving the metal halide.

The aprotic solvent may comprise at least one selected from the group consisting of DMF, NMP, THF, and DMSO.

To achieve the above object, an R-T-B based sintered magnet according to the exemplary embodiment of the present invention is an R-T-B based sintered magnet comprising:
a rare-earth metal element;
a transition metal element; and
boron,
wherein
the R-T-B based sintered magnet comprises main phases including an R₂T₁₄B compound and a grain boundary phase between the main phases; and
the R-T-B based sintered magnet comprises at least one selected from the group consisting of an R—Cl—O phase and an R—Cl—O—B phase.

The R-T-B based sintered magnet may comprise the R—Cl—O—B phase.

The R-T-B based sintered magnet may comprise 0.02 mass % or more and 0.70 mass % or less of chlorine.

The R-T-B based sintered magnet may comprise 0.05 mass % or more and 0.90 mass % or less of lithium.

The main phases may comprise at least one selected from the group consisting of the R—Cl—O phase and the R—Cl—O—B phase.

The grain boundary phase may comprise the R—Cl—O—B phase.

0.200≤[Cl]_{b1}/[R]_{b1}≤2.00 may be satisfied, where [R]_{b1} is a total atomic ratio of the rare-earth metal element included in the R—Cl—O—B phase and [Cl]_{b1} is an atomic ratio of chlorine included in the R—Cl—O—B phase.

10 at %≤[B]_{b1}≤20 at % may be satisfied, where [B]_{b1} is an atomic ratio of boron included in the R—Cl—O—B phase.

### BRIEF DESCRIPTION OF THE DRAWING(S)

FIG. 1 is a backscattered electron image of an R-T-B based sintered magnet of Example 2.

FIG. 2 is a secondary electron image of the R-T-B based sintered magnet of Example 2.

FIG. 3 is another backscattered electron image of the R-T-B based sintered magnet of Example 2.

FIG. 4 is a backscattered electron image of an R-T-B based sintered magnet of Example 6.

FIG. 5 is a secondary electron image of the R-T-B based sintered magnet of Example 6.

FIG. 6 is another backscattered electron image of the R-T-B based sintered magnet of Example 6.

FIG. 7 is a Cl mapping image of Example 6.

FIG. 8 is an O mapping image of Example 6.

FIG. 9 is a Nd mapping image of Example 6.

FIG. 10 is an Fe mapping image of Example 6.

FIG. 11 is a B mapping image of Example 6.

### DETAILED DESCRIPTION

Hereinafter, a method according to an embodiment of the present invention of manufacturing an R-T-B based sintered magnet will be described. Note that, the term “powder” means a collective entity of particles.

### [Preparation of Composition]

First, a composition constituting raw materials of the R-T-B based sintered magnet is prepared. The composition includes a rare-earth metal element, a transition metal element, boron, and a metal halide.

Typically, rare-earth metal elements include Sc, Y, and lanthanides. The composition may include any rare-earth metal elements. The rare-earth metal element in the composition may include at least one selected from the group consisting of Y, La, Pr, Nd, Sm, Eu, Gd, Tb, Dy, Ho, Er, Tm, Yb, and Lu; at least one selected from the group consisting of Pr, Nd, Tb, and Dy; or Nd. The rare-earth metal element included in the composition and the content ratio of the rare-earth metal element are adjusted in accordance with an intended composition of the R-T-B based sintered magnet.

The composition may include any transition metal elements. The transition metal element in the composition may include at least one selected from the group consisting of Fe, Ni, Co, Cr, and Mn or may include Fe. In the present embodiment, transition metal elements do not include rare-earth metal elements. The transition metal element included in the composition and the content ratio of the transition metal element are adjusted in accordance with the intended composition of the R-T-B based sintered magnet.

The content ratio of boron included in the composition is adjusted in accordance with the intended composition of the R-T-B based sintered magnet.

The metal halide in the composition includes at least one selected from the group consisting of an alkali metal halide, an alkaline earth metal halide, and a halide of the above-mentioned rare-earth metal element. Note that alkaline earth metals include Be and Mg other than Ca, Sr, Ba, and Ra.

The composition may include any halides. For example, fluoride, chloride, bromide, or iodide may be included.

Examples of alkali metal halides include LiCl, KCl, NaCl, and LiF. Examples of alkaline earth metal halides include CaCl₂, MgCl₂, BaCl₂, and SrCl₂. The halide may be LiCl.

The composition substantially does not include a simple substance of an alkali metal element or a simple substance of an alkaline earth metal element. Specifically, the simple substance of the alkali metal element and the simple substance of the alkaline earth metal element constitute 0.01 mass % or less of the composition in total.

The melting point of the simple substance of the alkali metal element and the melting point of the simple substance of the alkaline earth metal element are higher than the melting point of the alkali metal halide and the melting point of the alkaline earth metal halide, respectively. For example, while the melting point of a simple substance of calcium is 842° C., the melting point of a calcium halide is 772° C., and the melting point of a mixture of a calcium halide and a sodium halide is approximately 500° C.

Thus, when a composition substantially including the simple substance of the alkali metal element and/or the simple substance of the alkaline earth metal element is used, a heating temperature described later needs to be high. Consequently, the rare-earth metal element readily vaporizes at the time of heating (heat treatment) described later, and an alloy powder given by heating readily has an uneven composition. Further, particles included in the alloy powder given by heating readily have large sizes and are readily agglomerated.

Next, a method of producing the composition will be described.

First, the raw materials of the composition are prepared. Any raw materials of the rare-earth metal element, the transition metal element, and boron may be used. The raw materials may be simple substances of the elements, an alloy including the elements, or a compound including the elements. The raw materials may be prepared by a known method.

The above-mentioned raw materials may have any shapes. For example, the raw materials may be powdered, particulate, or in a form of an ingot. Particles included in the raw materials preferably have small sizes, because the particles included in the alloy powder to be given by steps described later readily have small sizes. For example, the average particle size of the particles included in the raw materials may be 1 μm or less.

The raw material of the metal halide may have any shape. For example, the raw material of the metal halide may be powdered. Also, the raw material of the metal halide may be sufficiently dried to remove moisture.

Then, the prepared raw materials are mixed to give the composition. Any mixing method may be used.

### [Production of Alloy Powder]

The composition is heated to give the alloy powder. The heating temperature is a temperature not lower than the melting point of the metal halide. When the raw material of the metal halide is a mixture of the metal halide and another substance, the eutectic point of the mixture shown in a phase diagram is deemed to be the melting point of the metal halide.

The heating temperature depends on the melting point of the metal halide. For example, the temperature is 300° C. or more and 1200° C. or less. Heating may be carried out at any temperature for any amount of time. For example, the heating temperature may be 500° C. or more and 800° C. or less, and the amount of time of heating may be 0.5 hours or more and 6 hours or less.

By heating, the metal halide melts to become a molten salt. In the molten salt, the raw material of the rare-earth metal element and the raw material of boron react with the raw material of the transition metal element and diffuse into the raw material of the transition metal element. Thus, the alloy powder including an R₂T₁₄B compound is generated, and the alloy powder is dispersed in the molten salt.

Mechanisms of the above reaction and diffusion are not clarified. It is assumed that the raw material of the rare-earth metal element and the raw material of boron dissolve into the molten salt to become a liquid phase. As the liquid phase and the raw material of the transition metal element are ready to react, the rare-earth metal element and boron are uniformly diffused into the raw material of the transition metal element. Also, it is assumed that the molten salt prevents agglomeration of particles included in the generated alloy powder, contributing to generation of the fine powder having an average particle size of less than 1 μm.

Note that, when heating is carried out without adding of the metal halide, the alloy powder including the R₂T₁₄B compound cannot be produced, and an alloy lump including the R₂T₁₄B compound is produced.

The total concentration of the rare-earth metal element in the molten salt is not limited. For example, the total concentration may be 0.5 mol/L or more and 4.0 mol/L or less. The total concentration of the rare-earth metal element in the molten salt required for generation of the R₂T₁₄B compound depends on the oxygen content of the raw materials. If the rare-earth metal element in the molten salt reacts with oxygen in the raw materials, oxide or acid chloride of the rare-earth metal element is generated. That is, the rare-earth metal element is consumed. Thus, the higher the oxygen content of the raw materials, the higher needs to be the total concentration of the rare-earth metal element in the molten salt.

### [Cleaning of Alloy Powder]

The above alloy powder is cleaned with a cleaning solution capable of dissolving the metal halide to remove the metal halide. The cleaning solution may be a cleaning solution having a solubility of the metal halide of 1.0 g/100 g or more or may be a cleaning solution having a solubility of the metal halide of 10 g/100 g or more. Using a cleaning solution incapable of dissolving the metal halide for cleaning the above alloy powder cannot remove the metal halide.

Here, the cleaning solution capable of dissolving the metal halide includes an aprotic solvent. The aprotic solvent is a solvent that does not include a hydroxyl group. Cleaning the alloy powder using the cleaning solution including the aprotic solvent enables prevention of oxidation of surfaces of the particles included in the alloy powder. Consequently, the R-T-B based sintered magnet having a high density in the end is given.

Any types of aprotic solvents may be used. For example, the aprotic solvent may include at least one selected from the group consisting of formamide (FA); N,N-dimethylformamide (DMF); N-methylpyrrolidone (NMP); tetrahydrofuran (THF); and dimethyl sulfoxide (DMSO). In particular, in terms of stability of the aprotic solvent, the aprotic solvent preferably includes at least one selected from the group consisting of DMF, NMP, THF, and DMSO.

Compared to DMF, NMP, THF, and DMSO, FA has lower stability and is readily decomposed to formic acid. When cleaning is carried out using a cleaning solution including FA, it is required to prevent decomposition of FA to formic acid.

When cleaning is carried out using a cleaning solution including a large amount of a protic solvent (e.g., water and alcohol) and/or acids, it is difficult to prevent oxidation of the surfaces of the particles included in the alloy powder. When the surfaces of the particles are oxidized to have oxidized layers, it is difficult to sufficiently improve the density of a sintered body described later.

The aprotic solvent may constitute 99 mass % or more of the cleaning solution in total or may constitute 100 mass % of the cleaning solution in total.

When the composition substantially includes the simple substance of the alkali metal element and/or the simple substance of the alkaline earth metal element, the above cleaning solution mainly including the aprotic solvent cannot dissolve the simple substances of the above metal elements. A cleaning solution mainly including a protic solvent can dissolve the simple substances of the above metal elements. Thus, when the composition includes the simple substances of the above metal elements, it is required to use the cleaning solution mainly including the protic solvent. However, cleaning using the cleaning solution mainly including the protic solvent oxidizes the surfaces of the particles included in the alloy powder, and the oxidized layers are formed. Thus, it is not possible to sufficiently increase the density of the sintered body obtained by sintering the alloy powder.

Further, ultrasonic cleaning may be used when the alloy powder is cleaned. Increasing the output at the time of ultrasonic cleaning can make the particles in the alloy powder finer and make main phases of the R-T-B based sintered magnet obtained in the end readily include at least one selected from the group consisting of an R—Cl—O phase and an R—Cl—O—B phase. Moreover, increasing the output at the time of ultrasonic cleaning enables the alloy powder to be cleaned more intensively. Consequently, the metal halide is removed more intensively. For example, when the metal halide is LiCl, the content of lithium, chlorine, and/or oxygen in the R-T-B based sintered magnet obtained in the end can be reduced.

### [Drying of Alloy Powder]

First, water adhered to the alloy powder may be removed. Specifically, water may be substituted by an organic solvent (e.g., acetone). Then, the alloy powder is dried. Any drying method may be used. For example, drying may be carried out at room temperature or more and 300° C. or less. Any atmosphere may be used as a drying atmosphere. For example, the drying atmosphere may be a vacuum, an argon atmosphere, or a nitrogen atmosphere.

The alloy powder obtained at this time can have smaller sizes of powder particles compared to an alloy powder obtained by the conventional process, which is pulverizing a R-T-B based alloy. Specifically, the particle sizes can be 0.1 μm or more and 20.0 μm or less or can be 0.1 μm or more and less than 1.0 μm. Moreover, use of the cleaning solution including the above aprotic solvent can make it difficult for the oxidized layers to be formed on the particles. Because the oxidized layers are not readily formed on the particles, the relative density of the sintered body described later can be improved.

### [Molding]

Next, the alloy powder is molded to give a green compact. Any method of producing the green compact may be used, and a known method can be used. For example, pressure-molding may be used.

When pressure-molding is performed, the molding pressure is not limited. For example, the molding pressure may be 100 MPa or more and 500 MPa or less.

### [Sintering]

Next, the green compact is sintered to give a sintered body. Any method of producing the sintered body may be used, and a known method can be used. For example, when a normal heat processing is carried out for sintering, the sintering temperature is not limited. For example, the sintering temperature may be 800° C. or more and 1200° C. or less. The sintering time is not limited. For example, the sintering time may be 0.5 hours or more and 6 hours or less. The sintering atmosphere is not limited. For example, the sintering atmosphere may be a vacuum or an argon atmosphere.

To confirm whether the sintered body is sufficiently sintered, its relative density may be checked. The relative density is calculated by dividing the measured density calculated by measurement of the weight and volume of the sintered body by the theoretical density of the R₂T₁₄B compound. When the relative density is 75% or more, the sintered body is deemed to be sufficiently sintered. The relative density may be 80% or more, 85% or more, or 90% or more.

The obtained sintered body may directly be the R-T-B based sintered magnet. The obtained sintered body may be appropriately processed, magnetized, etc. to give the R-T-B based sintered magnet.

Hereinafter, an R-T-B based sintered magnet according to the embodiment of the present invention will be described with reference to the drawings.

### [Composition]

The R-T-B based sintered magnet may have any composition. The R-T-B based sintered magnet at least includes a rare-earth metal element, a transition metal element, and boron.

Typically, rare-earth metal elements include Sc, Y, and lanthanides. The composition may include any rare-earth metal elements. The rare-earth metal element in the composition may include at least one selected from the group consisting of Y, La, Pr, Nd, Sm, Eu, Gd, Tb, Dy, Ho, Er, Tm, Yb, and Lu; at least one selected from the group consisting of Pr, Nd, Tb, and Dy; or Nd. The rare-earth metal element included in the R-T-B based sintered magnet and the content ratio of the rare-earth metal element are adjusted in accordance with intended characteristics of the R-T-B based sintered magnet.

The R-T-B based sintered magnet may include any transition metal elements. The transition metal element in the R-T-B based sintered magnet may include at least one selected from the group consisting of Fe, Ni, Co, Cr, and Mn or may include Fe. In the present embodiment, transition metal elements do not include rare-earth metal elements. The transition metal element included in the R-T-B based sintered magnet and the content ratio of the transition metal element are adjusted in accordance with the intended characteristics of the R-T-B based sintered magnet.

The content ratio of boron included in the R-T-B based sintered magnet is adjusted in accordance with the intended characteristics of the R-T-B based sintered magnet.

The R-T-B based sintered magnet further includes oxygen and chlorine. The oxygen content is not limited. For example, the oxygen content may be 0.10 mass % or more and 2.00 mass % or less, 0.10 mass % or more and 0.80 mass % or less, or 0.10 mass % or more and 0.15 mass % or less.

The chlorine content is not limited. For example, the chlorine content may be 0.01 mass % or more and 5.0 mass % or less, 0.02 mass % or more and 0.70 mass % or less, or 0.04 mass % or more and 0.20 mass % or less.

The R-T-B based sintered magnet may further include lithium. The lithium content is not limited. For example, the lithium content may be 0.05 mass % or more and 0.90 mass % or less or may be 0.06 mass % or more and 0.17 mass % or less.

### [Microstructure]

Hereinafter, two types of microstructures of R-T-B based sintered magnets will be described for illustration of the microstructures.

### (R-T-B Based Sintered Magnet 100)

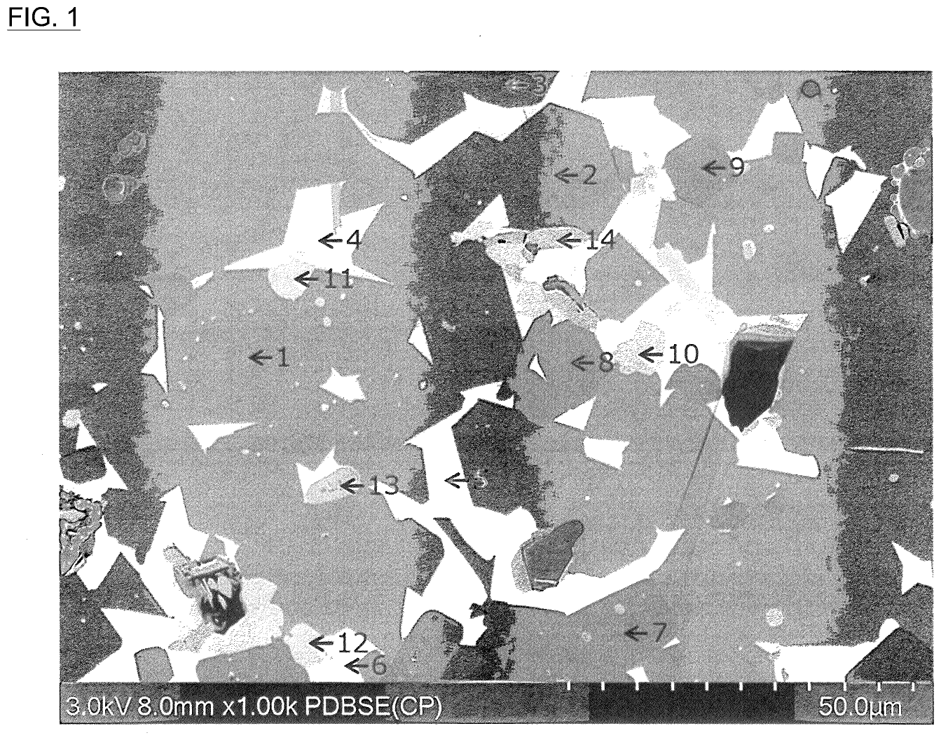

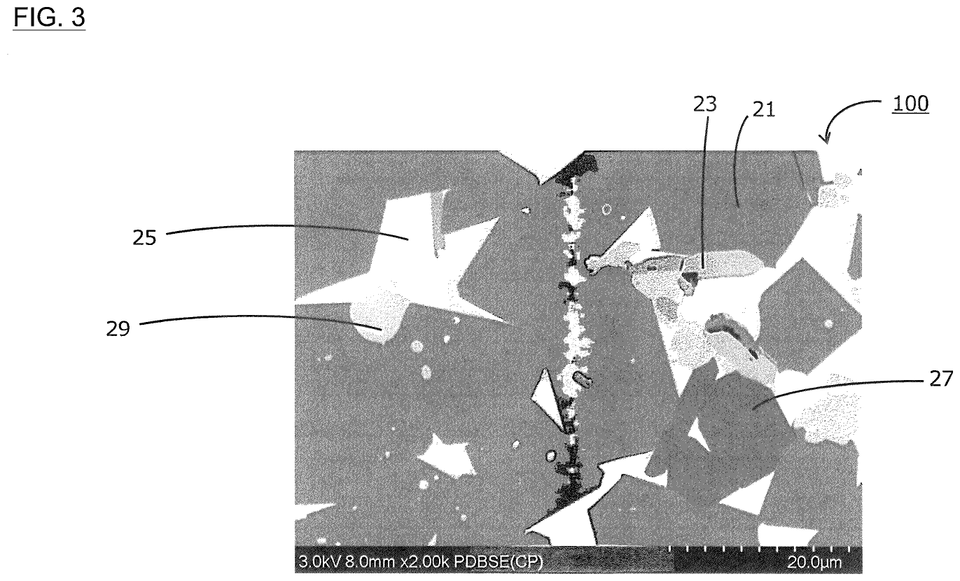

As shown in FIG. 3, an R-T-B based sintered magnet 100 includes main phases 21 including an R₂T₁₄B compound and a grain boundary phase between the main phases 21. Note that FIGS. 1 and 3 are backscattered electron images of a cross section of an R-T-B based sintered magnet of Example 2 described later observed with a SEM, and FIG. 3 is a partly enlarged backscattered electron image of FIG. 1. Any observation apparatus may be used. For example, a TEM or a STEM may be used other than the SEM.

The main phases 21 may have any average equivalent circle diameter. For example, the average equivalent circle diameter may be 1.0 μm or more and 100.0 μm or less. Note that an equivalent circle diameter is a diameter of a circle having the same area as the main phase 21.

The R₂T₁₄B compound is a compound having an R₂T₁₄B type crystal structure. “R” includes at least one element selected from rare-earth metal elements. “T” includes at least one element selected from transition metal elements. B is boron. Boron may be partly substituted by carbon.

The R-T-B based sintered magnet 100 includes an R—Cl—O—B phase 23. The R—Cl—O—B phase 23 is a phase at least including a rare-earth metal element, chlorine, oxygen, and boron. The area ratio of the R—Cl—O—B phase 23 in a cross section of the R-T-B based sintered magnet 100 is not limited. For example, the area ratio may be 0.1% or more and 20.0% or less. As shown in FIG. 3, the grain boundary phase may include at least one R—Cl—O—B phase 23.

The at least one R—Cl—O—B phase 23 included in the grain boundary phase may have any average equivalent circle diameter. For example, the average equivalent circle diameter may be 0.1 μm or more and 10.0 μm or less.

0.200≤[Cl]_{b1}/[R]_{b1}≤2.00 may be satisfied, where [R]_{b1} is the total atomic ratio of the rare-earth metal element included in the R—Cl—O—B phase 23 and [Cl]_{b1} is the atomic ratio of chlorine included in the R—Cl—O—B phase 23.

10 at %≤[B]_{b1}≤20 at % may be satisfied, where [B]_{b1} is the atomic ratio of boron included in the R—Cl—O—B phase 23.

The content ratio of each element in the R—Cl—O—B phase 23 may be an average content ratio. The same applies to the main phases 21 and an R-rich phase 25 described later.

Any method of measuring the content ratio of each element in the R—Cl—O—B phase 23 may be used. For example, an EPMA attached to the observation apparatus (e.g., SEM), SEM-EDS, or STEM-EDS may be used for point analysis.

To measure the average content ratio of each element, the point analysis may be performed at a sufficient number of measurement points for calculation of the average content ratio of each element to average the content ratios at the measurement points. When each type of phase is sufficiently compositionally uniform, the point analysis may be performed at one measurement point in each type of phase, and the obtained content ratio may be deemed to be the average content ratio of each type of phase.

As the grain boundary phase includes the R—Cl—O—B phase 23, grain growth of the R₂T₁₄B compound during sintering can be prevented, and coercivity of the R-T-B based sintered magnet can be improved. Additionally, because the R—Cl—O—B phase 23 includes oxygen, the oxygen content of the main phases 21 and the oxygen content of the R-rich phase 25 are reduced despite the sintered body having a high oxygen content as the average composition. That is, reaction between the R—Cl—O—B phase 23 with oxygen included in the main phases 21 and oxygen included in the R-rich phase 25 during sintering can facilitate sintering.

Any method may be used to make the R-T-B based sintered magnet 100 include the R—Cl—O—B phase 23. When a metal chloride is used as the metal halide in the above method of manufacturing the R-T-B based sintered magnet, the R-T-B based sintered magnet 100 obtained in the end may include the R—Cl—O—B phase 23.

In addition to the R—Cl—O—B phase 23, any other phases may be included in the R-T-B based sintered magnet 100. Phases that are known to be possibly included in the R-T-B based sintered magnet may be appropriately included. For example, phases such as the R-rich phase 25, a B-rich phase 27, and an R—C—O phase 29 may be included. The R-rich phase 25, the B-rich phase 27, the R—C—O phase 29, etc. may be included in the grain boundary phase.

Although there is no illustration in FIGS. 1 to 3, the R-T-B based sintered magnet 100 may include an R—Cl—O phase described later and/or an R—Cl phase described later. The R—Cl—O phase includes an R—Cl—O compound, which is a compound including “R”, Cl, and O at approximately R:Cl:O=1:1:1 in atomic ratio.

The content ratio of a rare-earth metal element in the R-rich phase 25 may be 70 at % or more and 95 at % or less. The content ratio of boron in the B-rich phase 27 may be 20 at % or more and 60 at % or less. The content ratio of chlorine in the R-rich phase 25 and the content ratio of chlorine in the B-rich phase 27 may be 0.1 at % or more and 5.0 at % or less.

### (R-T-B Based Sintered Magnet 200)

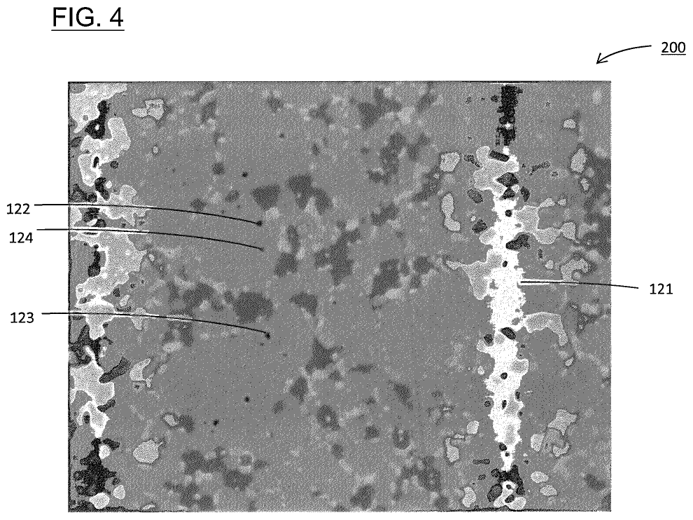

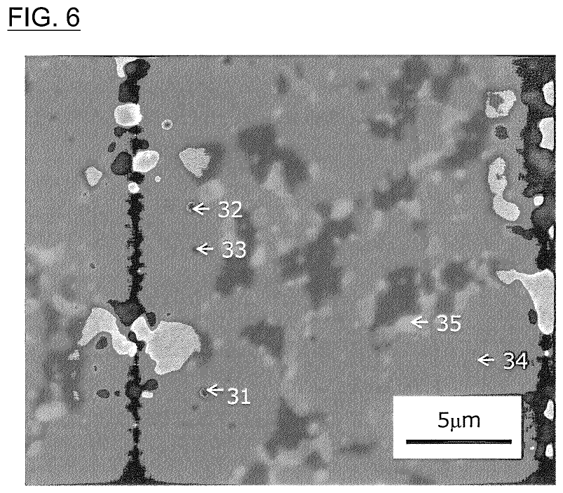

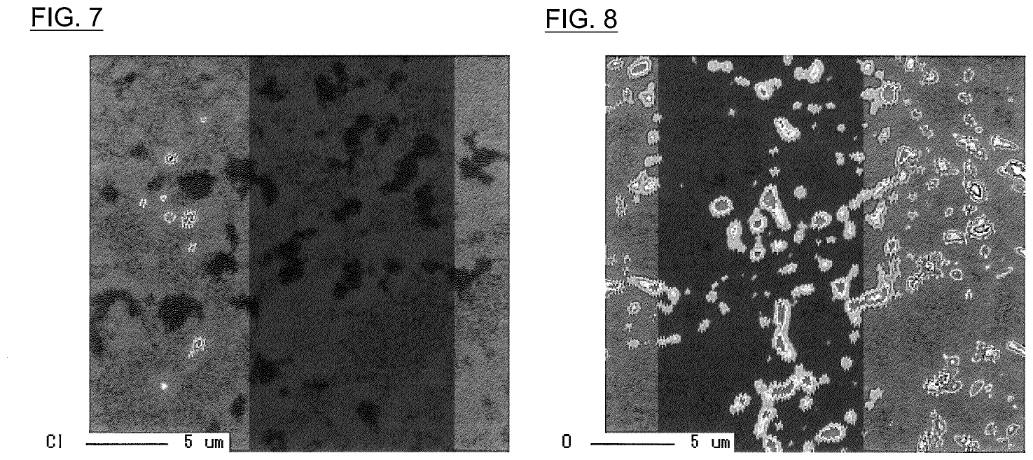

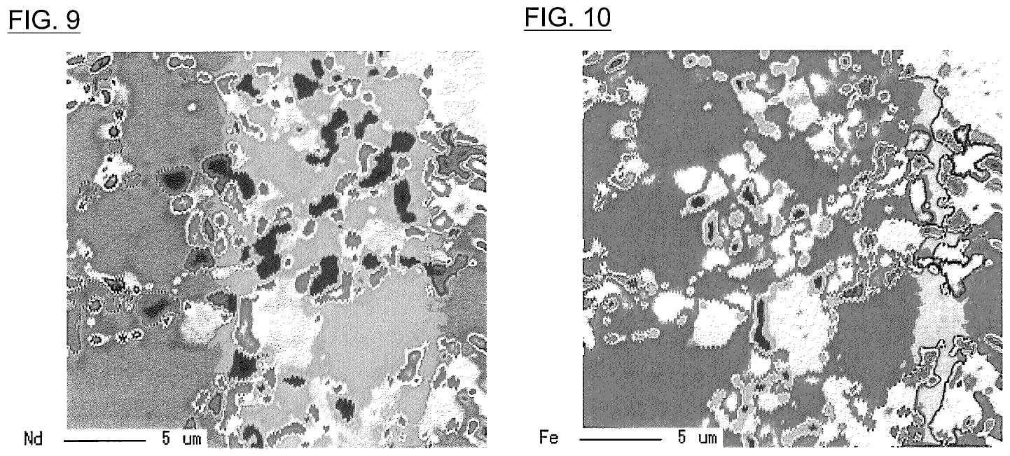

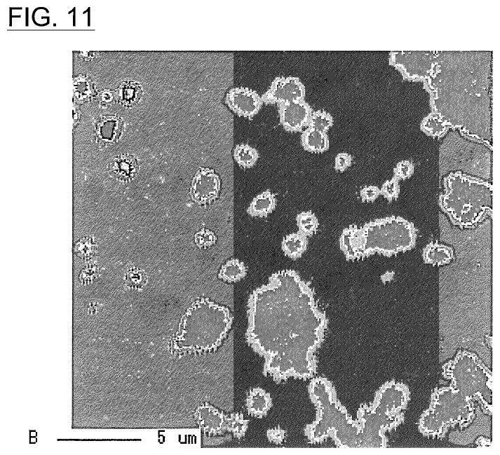

As shown in FIG. 4, an R-T-B based sintered magnet 200 includes main phases 121 including an R₂T₁₄B compound and a grain boundary phase between the main phases 121. Note that FIGS. 4 and 6 are backscattered electron images of a cross section of an R-T-B based sintered magnet of Example 6 described later observed with a SEM, and FIG. 6 is a partly enlarged backscattered electron image of FIG. 4. Any observation apparatus may be used. For example, a TEM or a STEM may be used other than the SEM. FIGS. 7 to 11 are elemental mapping images of the same field of view of FIG. 4, generated using SEM-EDS. Phases included in the R-T-B based sintered magnet 200 may be identified using the elemental mapping images.

The main phases 121 may have any average equivalent circle diameter. For example, the average equivalent circle diameter may be 0.1 μm or more and 20.0 μm or less.

The R-T-B based sintered magnet 200 includes at least one selected from the group consisting of an R—Cl—O phase and an R—Cl—O—B phase. The R—Cl—O phase is a phase at least including a rare-earth metal element, chlorine, and oxygen and substantially not including boron. The R—Cl—O—B phase is a phase at least including a rare-earth metal element, chlorine, oxygen, and boron. The total area ratio of the R—Cl—O phase and the R—Cl—O—B phase in a cross section of the R-T-B based sintered magnet 200 is not limited. For example, the total area ratio may be 1% or more and 10% or less. The R-T-B based sintered magnet 200 may include an R—Cl phase 124. The R—Cl phase 124 is a phase at least including a rare-earth metal element and chlorine and substantially not including oxygen or boron.

Note that the above phrase “substantially not including” regarding the R—Cl—O phase and the R—Cl phase 124 indicates that the content ratio is 1.0 at % or less.

Hereinafter, the R—Cl—O phase and the R—Cl—O—B phase may collectively be referred to as an R—Cl—O(—B) phase. This is because, particularly when the main phases include the R—Cl—O(—B) phase, whether the B content is 1.0 at % or less may not be identifiable due to a small size of the R—Cl—O(—B) phase.

As shown in FIG. 4, the main phases 121 may include R—Cl—O(—B) phases 122 and 123. The main phases 121 may further include the R—Cl phase 124. The R—Cl—O phase includes an R—Cl—O compound, which is a compound including “R”, Cl, and O at approximately R:Cl:O=1:1:1 in atomic ratio.

The R—Cl—O(—B) phases included in the main phases 121 may have any average equivalent circle diameter. For example, the average equivalent circle diameter may be 0.01 μm or more and 1.0 μm or less.

Any method of measuring the content ratio of each element in the phases, such as the R—Cl—O(—B) phases 122 and 123, may be used. For example, an EPMA attached to the observation apparatus (e.g., SEM), SEM-EDS, or STEM-EDS may be used for point analysis.

Any method may be used to make the R-T-B based sintered magnet 200 include the R—Cl—O(—B) phases 122 and 123. When a metal chloride is used as the metal halide in the above method of manufacturing the R-T-B based sintered magnet, the R-T-B based sintered magnet 200 obtained in the end may include the R—Cl—O(—B) phases 122 and 123.

In addition to the R—Cl—O(—B) phases 122 and 123 and the R—Cl phase 124, any other phases may be included in the R-T-B based sintered magnet 200. Phases that are known to be possibly included in the R-T-B based sintered magnet may be appropriately included. For example, phases such as an R-rich phase, a B-rich phase, and an R—C—O phase may be included. The R-rich phase, the B-rich phase, the R—C—O phase, etc. may be included in the grain boundary phase.

The content ratio of a rare-earth metal element in the R-rich phase may be 70 at % or more and 95 at % or less. The content ratio of boron in the B-rich phase may be 20 at % or more and 60 at % or less. The content ratio of chlorine in the R-rich phase and the content ratio of chlorine in the B-rich phase may be 0.1 at % or more and 5.0 at % or less.

### [Crystal Structure]

When an X-ray diffraction profile of the R-T-B based sintered magnet is generated using XRD, a peak attributable to the crystal structure of the R—Cl—O compound may be observed in addition to peaks attributable to the R₂T₁₄B type crystal structure and an RT₄B₄ type crystal structure. The R—Cl—O phase may be a crystal phase including a crystal of the R—Cl—O compound, and the R—Cl—O—B phase may be a crystal phase including a crystal of the R—Cl—O compound.

### EXAMPLES

Hereinafter, the present invention will be specifically described with examples.

### Examples 1 to 3, Comparative Examples 2 to 5, Reference Example 1

### [Production of Iron Powder]

First, iron nitrate (101.8 g) and calcium nitrate (14.9 g) were dissolved in water (819 mL) to give an aqueous solution. Then, while the aqueous solution was being stirred, a potassium hydroxide aqueous solution (441 mL) having a concentration of 1 mol/L was dropped into the former aqueous solution to give a suspension. The suspension was filtered to collect a residue. The collected residue was cleaned and then dried using a hot air drying oven in air at 120° C. for one night to give an iron oxide powder. The iron oxide powder was reduced in a hydrogen airflow at 500° C. for 6 hours to give an iron powder.

### [Production of Alloy Powder]

The iron powder (0.48 g), a neodymium powder (0.60 g), a sufficiently dried lithium chloride powder (2.07 g), and a boron powder (0.10 g) were put into a crucible made of iron and were mixed to give a composition. The powders other than the iron powder were appropriately prepared. Then, the composition was heated (heat treatment) in an Ar atmosphere at 800° C. for 3 hours to give an alloy powder. Note that the melting point of lithium chloride is 605° C. to 613° C.

### [Cleaning of Alloy Powder]

The alloy powder was taken out from the crucible. Then, the alloy powder was cleaned using ultrasonic cleaning with a solvent described in Table 1 as a cleaning solution. The output of an ultrasonic cleaning apparatus was 50 W. In Table 1, EG indicates ethylene glycol; FA indicates formamide; DMF indicates N,N-dimethylformamide; NMP indicates N-methylpyrrolidone; and THF indicates tetrahydrofuran. The amount of the solvent and the amount of time of cleaning were those sufficient for removing lithium chloride. When an organic solvent was used as a cleaning solution, an anhydrous organic solvent was used.

### [Drying of Alloy Powder]

Water adhered to the alloy powder was substituted by acetone. Then, the alloy powder was vacuum dried at room temperature (20° C.) for 24 hours.

### [Molding of Alloy Powder]

The alloy powder (about 0.1 g) was introduced into a mold with a size of Φ 4.5 mm. Then, the alloy powder was pressed at a pressure of 150 MPa to give a green compact.

### [Sintering]

The green compact was heated in a vacuum at 1050° C. for 3 hours for sintering the green compact to produce an R-T-B based sintered magnet (a sintered body).

### [Measurement of Relative Density]

The weight of the R-T-B based sintered magnet was measured with an electronic scale. The volume of the R-T-B based sintered magnet was calculated using the dimensions of the sintered body measured with a micrometer. Using the weight and the volume, the measured density of the R-T-B based sintered magnet was calculated. The measured density was divided by the theoretical density of the R₂T₁₄B compound (Nd₂Fe₁₄B compound), which was 7.62 g/cm³, to calculate the relative density. When the relative density was 75% or more, the relative density was deemed good. When the relative density was 80% or more, the relative density was deemed better. When the relative density was 85% or more, the relative density was deemed still better. When the relative density was 90% or more, the relative density was deemed best. Table 1 shows the results.

### [Measurement of Magnetic Characteristics]

A magnetic field of 0 to 25000 Oe was applied to the R-T-B based sintered magnet of each Example at room temperature using a vibrating sample magnetometer (VSM manufactured by TAMAKAWA CO., LTD.) to measure the magnetic characteristics (residual magnetism and coercivity). When the residual magnetism was 3.0 kG or more, the residual magnetism was deemed good. When the residual magnetism exceeded 3.5 kG, the residual magnetism was deemed better. When the residual magnetism exceeded 4.0 kG, the residual magnetism was deemed best. When the coercivity was 5.0 kOe or more, the coercivity was deemed good. When the coercivity exceeded 6.0 kOe, the coercivity was deemed better. When the coercivity exceeded 6.5 kOe, the coercivity was deemed best.

### Comparative Example 1

Comparative Example 1 was carried out under the same conditions as in Comparative Example 2 except that the alloy powder was produced using a Ca reduction diffusion method.

First, a neodymium oxide powder (2.146 g), a ferroboron powder (0.349 g) having a B content ratio of 19.1 wt %, the iron powder (3.287 g), and a metal calcium powder (1.010 g) were prepared. Then, the powders were mixed to give a mixture.

The mixture was put into a cylindrical stainless container. The stainless container was placed in a soaking area of an electric furnace, heated in an Ar gas airflow to reach 1000° C., and was held there for 7 hours. Then, the stainless container was cooled to reach 750° C. and was held there for 6 hours. Then, the Ar gas airflow was suspended, and the pressure inside the electric furnace was reduced using a rotary pump while the temperature remained 750° C. for another 6 hours.

Then, the temperature was cooled to room temperature while the inside of the furnace was provided with the Ar gas airflow again, to give the alloy powder. Cleaning of the alloy powder and the subsequent steps were the same as in Comparative Example 2. Table 1 shows the results.

TABLE 1

| | | | Effects | | |
|---|---|---|---|---|---|
| | | | Relative | Residual | |
| | Cleaning | | density | magnetism | Coercivity |
| | solution | Protic/aprotic | (%) | (kG) | (kOe) |
| Comparative Example 1 | Water | Protic | 50 | — | — |
| Comparative Example 2 | Water | Protic | 52 | — | — |
| Comparative Example 3 | Methanol | Protic | 52 | — | — |
| Comparative Example 4 | Ethanol | Protic | 51 | — | — |
| Comparative Example 5 | EG | Protic | 53 | — | — |
| Reference Example 1 | FA | Aprotic | 58 | — | — |
| Example 1 | DMF | Aprotic | 88 | 3.8 | 6.5 |
| Example 2 | NMP | Aprotic | 87 | 3.8 | 6.4 |
| Example 3 | THF | Aprotic | 89 | 3.9 | 6.3 |

According to Table 1, regarding the R-T-B based sintered magnet of each Example, sintering sufficiently proceeded, and the relative density was sufficiently high. Moreover, the R-T-B based sintered magnet of Example 2 had high magnetic characteristics. In contrast, regarding each Comparative Example and Reference Example 1, sintering did not sufficiently proceed, and the relative density of the sintered body was not sufficiently high.

It is assumed that the reason why sintering did not sufficiently proceed in Reference Example 1 is that, since FA was decomposed to formic acid, oxidized layers were formed on a surface of the alloy powder.

Next, a cross section of the R-T-B based sintered magnet of Example 2 was observed.

The R-T-B based sintered magnet of Example 2 was embedded in an epoxy based resin. Then, the R-T-B based sintered magnet was cut, and the resulting cross section was polished. For polishing, commercially available abrasive papers were used. Specifically, multiple types of commercially available abrasive papers of Nos. 180 to 2000 were prepared. Further, using the abrasive papers starting from those having smaller numbers, the cross section of the R-T-B based sintered magnet was polished. Finally, buff and diamond abrasive grains were used for polishing. Note that, liquid (e.g., water) was not used for polishing in order to avoid corrosion of components included in the grain boundary phase.

The cross section of the R-T-B based sintered magnet was subject to an ion milling treatment, and influence, such as an oxide layer and a nitride layer at the outermost surface, was removed. Then, the cross section of the sintered body was observed using a FE-SEM to give a backscattered electron image. The observation magnification was 1000×. FIG. 1 shows the results.

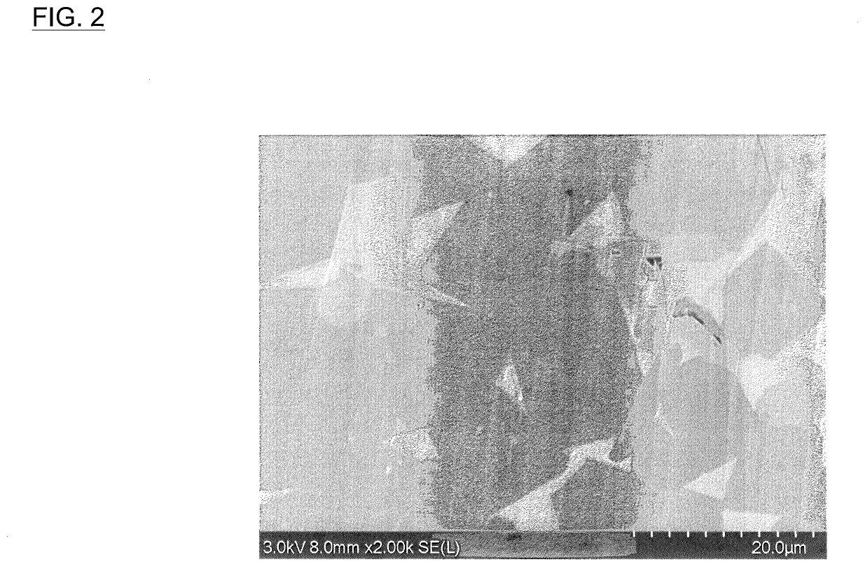

A part of FIG. 1 was observed at a magnification of 2000× to give a secondary electron image and a backscattered electron image. FIGS. 2 and 3 show the results.

Using the contrast of the backscattered electron images obtained in the observation, it was confirmed that main phases and a grain boundary phase were included. By appropriately performing point analysis of the main phases and the grain boundary phase using an EPMA attached to the FE-SEM, it was also confirmed that the grain boundary phase included R-rich phases, B-rich phases, R—C—O phases, and R—Cl—O—B phases. FIG. 1 shows measurement points of the point analysis. Table 2 shows the measurement results of the point analysis.

In the point analysis at points 1 to 12, the content ratios of Nd, Fe, B, C, N, and O were analyzed. In the point analysis at points 13 and 14, the content ratios of Nd, Fe, B, Cl, C, N, and O were analyzed.

Points 1 to 12 did not include Cl or had a low Cl content ratio. The analysis of the Cl content ratio is readily affected by noise. Accurately analyzing the Cl content ratio at points 1 to 12 would have taken time. Thus, in the point analysis at points 1 to 12, the Cl content ratio was not analyzed.

As for the measurement results of the point analysis, the content ratio of each element whose content ratio was measured was rounded off to one decimal place. Thus, the total of the content ratios of the elements whose content ratios were measured may not be 100.0 at %.

Points 1 to 3 belonged to the main phases. Points 4 to 6 belonged to the R-rich phases. Points 7 to 9 belonged to the B-rich phases. Points 10 to 12 belonged to the R—C—O phases. Points 13 to 14 belonged to the R—Cl—O—B phases.

TABLE 2

| | | Point analysis results (at %) | | | | | | | [Cl]/ |
|---|---|---|---|---|---|---|---|---|---|
| Point | Phase | Nd | Fe | B | Cl | C | N | O | [R] |
| 1 | Main phase | 11.2 | 79.4 | 5.3 | — | 3.9 | 0.0 | 0.3 | — |
| 2 | Main phase | 11.2 | 79.3 | 5.2 | — | 4.0 | 0.0 | 0.3 | — |
| 3 | Main phase | 11.2 | 79.5 | 5.5 | — | 3.2 | 0.0 | 0.5 | — |
| 4 | R-rich phase | 87.7 | 1.1 | 0.0 | — | 9.0 | 0.0 | 2.0 | — |
| 5 | R-rich phase | 90.4 | 1.6 | 0.0 | — | 6.2 | 0.2 | 1.6 | — |
| 6 | R-rich phase | 91.7 | 0.9 | 0.0 | — | 5.7 | 0.0 | 1.7 | — |
| 7 | B-rich phase | 12.3 | 43.9 | 41.0 | — | 2.7 | 0.0 | 0.2 | — |
| 8 | B-rich phase | 12.6 | 44.9 | 38.2 | — | 4.0 | 0.0 | 0.3 | — |
| 9 | B-rich phase | 12.9 | 45.9 | 37.5 | — | 3.4 | 0.0 | 0.3 | — |
| 10 | R—C—O phase | 49.9 | 0.4 | 0.0 | — | 14.4 | 3.2 | 32.0 | — |
| 11 | R—C—O phase | 48.9 | 0.9 | 0.0 | — | 17.6 | 4.8 | 27.7 | — |
| 12 | R—C—O phase | 49.9 | 1.1 | 0.0 | — | 15.2 | 5.0 | 28.6 | — |
| 13 | R—Cl—O—B phase | 24.3 | 1.9 | 13.9 | 34.5 | 3.9 | 0.0 | 21.5 | 1.42 |
| 14 | R—Cl—O—B phase | 25.5 | 0.9 | 14.1 | 35.5 | 1.6 | 0.0 | 22.5 | 1.39 |

According to Table 2 and FIGS. 1 to 3, it was confirmed that the R-T-B based sintered magnet of Example 2 included the R—Cl—O—B phases other than the main phases. Further, it was confirmed that the R-rich phases, the B-rich phases, and the R—C—O phases were included. Moreover, it was confirmed that the R—Cl—O—B phases had higher values of [Cl]/[R] than the phases other than the R—Cl—O—B phases did and that the values were 0.200 or more and 2.00 or less.

In FIG. 3, the R-rich phase 25 has a mottled pattern. It is assumed that this is because portions including a lot of carbon are distributed in a mottled pattern.

In Example 2, the average equivalent circle diameter of the R—Cl—O—B phases included in the grain boundary phase was measured. The average equivalent circle diameter was 9.3 μm.

As in Example 2, it was confirmed that the grain boundary phase included the R—Cl—O—B phase in Examples 1 and 3.

Moreover, in Examples 1 to 3, an X-ray diffraction profile of the R-T-B based sintered magnet was generated using XRD. In Examples 1 to 3, a peak attributable to the crystal structure of the R—Cl—O compound was observed in addition to peaks attributable to the R₂T₁₄B type crystal structure and the RT₄B₄ type crystal structure.

### Examples 4 to 6

Examples 4 to 6 were carried out as in Example 2 except for the following.

### [Production of Alloy Powder]

The iron powder (0.90 g), a neodymium powder, a sufficiently dried lithium chloride powder (3.11 g), and a boron powder (0.08 g) were put into a crucible made of iron and were mixed to give a composition. The amount of the neodymium powder added was 0.76 g in Example 4, 0.70 g in Example 5, and 0.59 g in Example 6.

The output of the ultrasonic cleaning apparatus for cleaning the alloy powder was 300 W. Table 3 shows the results.

TABLE 3

| | | | Effects | | |
|---|---|---|---|---|---|
| | | | Relative | Residual | |
| | Cleaning | Protic/ | density | magnetism | Coercivity |
| | solution | aprotic | (%) | (kG) | (kOe) |
| Example 4 | NMP | Aprotic | 77 | 3.5 | 6.0 |
| Example 5 | NMP | Aprotic | 83 | 3.7 | 6.5 |
| Example 6 | NMP | Aprotic | 91 | 4.1 | 6.8 |

According to Table 3, it was confirmed that, despite the composition of the alloy powder, manufacturing conditions, etc. being changed, the R-T-B based sintered magnet having good magnetic characteristics could be obtained.

Examples 4 to 6 had different relative densities. The relative density of Example 4 was lower than that of Examples 1 to 3. The relative density of Example 5 was almost equivalent to that of Examples 1 to 3. The relative density of Example 6 was higher than that of Examples 1 to 3. Consequently, Example 4 had lower magnetic characteristics than other Examples did, and Example 6 had higher magnetic characteristics than other Examples did.

A cross section of the R-T-B based sintered magnet of Example 6 was observed.

The R-T-B based sintered magnet of Example 6 was embedded in an epoxy based resin. Then, the R-T-B based sintered magnet was cut, and the resulting cross section was polished. For polishing, commercially available abrasive papers were used. Specifically, multiple types of commercially available abrasive papers of Nos. 180 to 2000 were prepared. Further, using the abrasive papers starting from those having smaller numbers, the cross section of the R-T-B based sintered magnet was polished. Finally, buff and diamond abrasive grains were used for polishing. Note that, liquid (e.g., water) was not used for polishing in order to avoid corrosion of components included in the grain boundary phase.

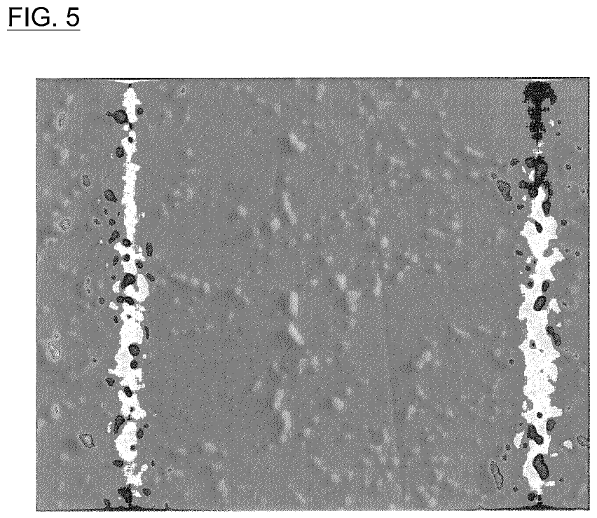

The cross section of the R-T-B based sintered magnet was subject to the ion milling treatment, and influence, such as an oxide layer and a nitride layer at the outermost surface, was removed. Then, the cross section of the sintered body was observed using the FE-SEM to give a secondary electron image and a backscattered electron image. The observation magnification was 3000×. FIG. 4 is the backscattered electron image. FIG. 5 is the secondary electron image.

Further, a part of FIG. 4 was observed at a magnification of 5000× to give a backscattered electron image. FIG. 6 is this backscattered electron image. Elemental mapping of FIG. 4 was carried out using SEM-EDS. FIGS. 7 to 11 show the results.

Using the contrast of the backscattered electron images obtained in the observation, it was confirmed that main phases and a grain boundary phase were included. By appropriately performing point analysis of the main phases and the grain boundary phase using the EPMA attached to the FE-SEM, it was also confirmed that the main phases included an R—Cl phase and R—Cl—O(—B) phases. FIG. 6 shows measurement points of the point analysis. Table 4 shows the measurement results of the point analysis.

In the point analysis at points 31 to 35, the content ratios of Nd, Fe, B, Cl, C, N, and O were analyzed.

At points 31 to 34, N was not detected. That is, points 31 to 34 did not include N or had a low N content ratio. At points 32 to 35, B was not detected. That is, points 32 to 35 did not include B or had a low B content ratio. At point 33, O was not detected. That is, point 33 did not include O or had a low O content ratio. At points 34 and 35, Cl was not detected. That is, points 34 and 35 did not include Cl or had a low Cl content ratio.

As for the measurement results of the point analysis, the content ratio of each detected element was rounded off to one decimal place. Thus, the total of the content ratios of the elements may not be 100.0 at %.

Points 31 and 32 belonged to the R—Cl—O(—B) phases. Point 33 belonged to the R—Cl phase. Point 34 belonged to one of the main phases. Point 35 belonged to the grain boundary phase of some kind.

TABLE 4

| | | Point analysis results (at %) | | | | | | | [Cl]/ |
|---|---|---|---|---|---|---|---|---|---|
| Point | Phase | Nd | Fe | B | Cl | C | N | O | [R] |
| 31 | R—Cl—O(—B) phase | 9.5 | 42.6 | 35.2 | 3.0 | 8.4 | — | 0.8 | 0.32 |
| 32 | R—Cl—O(—B) phase | 14.0 | 60.8 | — | 7.4 | 13.3 | — | 3.9 | 0.53 |
| 33 | R—Cl phase | 11.1 | 73.9 | — | 1.4 | 12.6 | — | — | — |
| 34 | Main phase | 11.3 | 73.1 | — | — | 13.6 | — | 0.6 | — |
| 35 | Grain boundary phase | 17.7 | 37.9 | — | — | 16.3 | 5.2 | 22.2 | — |

According to FIG. 6 and Table 4, the main phases of the R-T-B based sintered magnet of Example 6 had smaller sizes per phase than those of the R-T-B based sintered magnet of Example 2 did. Moreover, the main phases of the R-T-B based sintered magnet of Example 6 included the R—Cl—O(—B) phases.

FIG. 6 had a larger magnification than FIG. 1 did, and the points of the point analysis in FIG. 6 were smaller. Further, both the R—Cl—O(—B) phases and the R—Cl phase included in the main phases were small. Thus, it was more difficult to measure the accurate content ratios of the elements in the point analysis at points 31 to 35 than at points 1 to 14. Moreover, the elements included at relatively low content ratios tended to be undetected. For example, while it was assumed that point 34 included B at about 6 at % because point 34 belonged to a main phase grain, B was not detected at point 34 in the point analysis.

The results of measurement of the compositions of points 31 to 33 shown in Table 4 were affected by the surrounding main phases. Thus, it is assumed that the compositions of points 31 to 33 shown in Table 4 had a particularly higher Fe content ratio than the actual compositions of points 31 to 33 did.

The average equivalent circle diameter of the R—Cl—O(—B) phases included in the main phases of Example 6 was measured. The average equivalent circle diameter was 0.6 μm.

Also in Examples 4 and 5, it was confirmed that the main phases included the R—Cl—O—B phase as in Example 6.

### Compositions of Examples 1 to 6

The respective compositions of the R-T-B based sintered magnets of Examples 1 to 6 were measured. Table 5 shows the results. The content ratios of Nd, Fe, B, Li, and Ca were measured using ICP. The Cl content ratio was measured using firing ion chromatography. The O content ratio was measured using an inert gas fusion—non-dispersive infrared absorption method. Table 5 shows the content ratios of Nd, Fe, and B with one decimal place and the content ratios of Li, Cl, and O with two decimal places. Thus, the total of the content ratios of all elements may not be 100.0 at %.

TABLE 5

| | Sintered body composition (mass %) | | | | | | |
|---|---|---|---|---|---|---|---|
| | Nd | Fe | B | Li | Cl | O | Ca |
| Example 1 | 42.0 | 52.7 | 2.5 | 1.10 | 0.85 | 0.88 | — |
| Example 2 | 42.8 | 52.7 | 2.2 | 0.90 | 0.62 | 0.74 | — |
| Example 3 | 41.1 | 54.0 | 1.9 | 1.20 | 0.93 | 0.85 | — |
| Example 4 | 35.6 | 60.1 | 4.2 | 0.07 | 0.04 | 0.13 | — |
| Example 5 | 35.1 | 61.0 | 3.8 | 0.06 | 0.07 | 0.10 | — |
| Example 6 | 33.1 | 61.3 | 3.6 | 0.17 | 0.20 | 0.15 | — |

According to Table 5, it was confirmed that, particularly the content ratios of Li, Cl, and O of Examples 4 to 6 were smaller than those of Examples 1 to 3. Note that Ca was not detected in any of Examples.

### REFERENCE NUMERALS

100, 200 . . . R-T-B based sintered magnet
21, 121 . . . main phase
122, 123 . . . R—Cl—O(—B) phase
23 . . . R—Cl—O—B phase
124 . . . R—Cl phase
25 . . . R-rich phase
27 . . . B-rich phase
29 . . . R—C—O phase

What is claimed is:

1. A method of manufacturing an R-T-B based sintered magnet, comprising:
heating a composition to give an alloy powder;
cleaning the alloy powder using a cleaning solution;
molding the cleaned alloy powder to give a green compact; and
sintering the green compact to give a sintered body,
wherein
the composition comprises a rare-earth metal element, a transition metal element, boron, and a metal halide;
the metal halide comprises at least one selected from the group consisting of an alkali metal halide, an alkaline earth metal halide, and a halide of the rare-earth metal element;
the heating is performed at a heating temperature that is not lower than a melting point of the metal halide; and
the cleaning solution comprises an aprotic solvent and is capable of dissolving the metal halide.

2. The method of manufacturing an R-T-B based sintered magnet according to claim 1, wherein the aprotic solvent comprises at least one selected from the group consisting of DMF, NMP, THF, and DMSO.

3. An R-T-B based sintered magnet comprising:
a rare-earth metal element;
a transition metal element; and
boron,
wherein
the R-T-B based sintered magnet comprises main phases including an R₂T₁₄B compound and a grain boundary phase between the main phases; and
the R-T-B based sintered magnet comprises at least one selected from the group consisting of an R—Cl—O phase and an R—Cl—O—B phase.

4. The R-T-B based sintered magnet according to claim 3 comprising the R—Cl—O—B phase.

5. The R-T-B based sintered magnet according to claim 3 comprising 0.02 mass % or more and 0.70 mass % or less of chlorine.

6. The R-T-B based sintered magnet according to claim 3 comprising 0.05 mass % or more and 0.90 mass % or less of lithium.

7. The R-T-B based sintered magnet according to claim 3, wherein the main phases comprise at least one selected from the group consisting of the R—Cl—O phase and the R—Cl—O—B phase.

8. The R-T-B based sintered magnet according to claim 3, wherein the grain boundary phase comprises the R—Cl—O—B phase.

9. The R-T-B based sintered magnet according to claim 8, wherein 0.200≤[Cl]_{b1}[R]_{b1}≤2.00 is satisfied, where [R]_{b1} is a total atomic ratio of the rare-earth metal element included in the R—Cl—O—B phase and [Cl]_{b1} is an atomic ratio of chlorine included in the R—Cl—O—B phase.

10. The R-T-B based sintered magnet according to claim 8, wherein 10 at %≤[B]_{b1}≤20 at % is satisfied, where [B]_{b1} is an atomic ratio of boron included in the R—Cl—O—B phase.
